(19) United States
(12) Patent Application Publication
(10) Pub. No.: US 2001/0047054 A1
(43) Pub. Date: Nov. 29, 2001

(54) Flexible water absorbent polymer coating

(76) Inventors: Richard F. Zopf, Derry, NH (US); Brian D. Thiffault, Belleville (CA)

Correspondence Address: James T. Sullivan, Bourque & Associates, P.A., Suite 303, 835 Hanover Street, Manchester, NH, 03104, US

(21) Appl. No.: 09/885,845

(22) Filed: Jun. 20, 2001

Related U.S. Application Data
(62) Division of application No. 09/225,696, filed on Jan. 6, 1999, now abandoned.

(51) Int. Cl. C08F 220/06; C08F 226/00; C08F 220/46

(52) U.S. Cl. 524/815; 526/75; 526/312; 526/317.1; 526/238.21; 526/238.22

(57) ABSTRACT

The present invention provides a liquid water-swellable coating compound, which is substantially devoid of volatile non-reactives. The water-swellable coating compound can be applied, to an article and cross-linked in place on the article to create a water-swellable, super absorbent polymer coating. The super absorbent polymer coating of the present invention is a flexible water-absorbent coating and comprises a cross-linked polymer prepared by polymerizing a reactive mixture, which comprises: substantially between thirty-five weight percent (35%) and ninety-nine and nine-tenths weight percent (99.9%) of one or more amine neutralized monomer; substantially between one tenth of one weight percent (0.1%) and fifteen weight percent (15%) cross-linking monomer; substantially between zero weight percent (0%) and fifty weight percent (50%) water soluble, substantially monofunctional oligomer; and substantially between one-half of one weight percent (0.5%) and five weight percent (5%) of an appropriate cross-linking agent.

### FIELD OF THE INVENTION

This invention relates to a flexible, water-swellable polymer coating made from cross-linking polyacrylates and a method for their manufacture.

### BACKGROUND OF THE INVENTION

Water-absorbent or water-swellable polymers are well known. These polymers, also referred to as aqueous fluid absorbent polymers or super absorbent polymers, are primarily used in personal care products which absorb body fluids, for example, disposable diapers. They are also incorporated into absorbent structures which contain synthetic and/or natural fiber or paper based, woven and nonwoven products, such as surgical sponges and paper towels.

These super absorbent polymers quickly absorb fluids and retain such fluids to prevent leakage and give the absorbent structure a “dry feel” even when wetted. Examples of super absorbent polymers can be found in U.S. Pat. Nos. 4,041,231, 4,061,846, 4,295,987, 4,535,098, 5,629,377 and others. While the prior art teaches super absorbent polymers having varying qualities, they all share a common theme. Specifically, the prior art super absorbent polymers all begin with a carboxyl containing monomer of monomers, which are neutralized to create an organic salt and water. The neutralized salt is two-dimensionally cross-linked. The water is then evaporated from the solution using a drying process. The resultant two-dimensionally cross-linked polymer is then ground, comminuted or extruded to create super absorbent powders, particles and fibers. The particles or fibers are then three-dimensionally cross-linked to provide structure, liquid retention capabilities to the polymer. These three-dimensionally cross-linked super-absorbent polymers are then incorporated into other structures to produce super absorbent articles, such as disposable diapers.

One disadvantage of prior art super-absorbent polymeric powders and their manufacture involves the prior art neutralization methods. Since prior art neutralizing methods all create a neutralized salt and water, the water must be evaporated in order to obtain the water absorbent polymer. While many techniques have been utilized to evaporate the water from the neutralized salt solution, they all involve heat and/or time. Accordingly, they are not conducive high speed manufacturing techniques. Additionally, if the super-absorbent polymer is fully cross-linked, the water is given up very slowly, which increases the time required for the manufacturing process.

In addition, there are many applications where super-absorbent polymeric powders or fibers are not acceptable. Accordingly, there is a need for liquid applied, super-absorbent polymer coatings. Prior art attempts of providing super-absorbent polymer coatings all involve the use of prior art super-absorbent polymeric powders, which are embedded into various liquid coating carrier systems. The coating systems themselves are not absorbers at all and therefore compromise the total absorbency of the super-absorbent powder included therein.

Accordingly, there is a need for a super absorbent polymer coating compound, which can be manufactured in a single process, which comprises one hundred percent solids and which is substantially devoid of volatile non-reactives.

### SUMMARY OF THE INVENTION

The present invention provides a super-absorbent polymer coating compound. This disclosed super-absorbent polymer coating compound comprises an amine neutralized acrylic acid liquid monomer blend including a cross-linking monomer, which is a liquid substantially devoid of volatile non-reactives. The liquid monomer blend can be applied, to a substrate and cross-linked in place on the substrate to create a water-swellable, super absorbent polymer coating. The super absorbent polymer coating of the present invention is a flexible water-absorbent coating and comprises a cross-linked polymer prepared by polymerizing a reactive mixture, which comprises: substantially between thirty-five weight percent (35%) and ninety-nine and nine-tenths weight percent (99.9%) of one or more amine neutralized monomer; substantially between one tenth of one weight percent (0.1%) and fifteen weight percent (15%) cross-linking monomer; substantially between zero weight percent (0%) and fifty weight percent (50%) water soluble, substantially monofunctional oligomer; and substantially between one-half of one weight percent (0.5%) and five weight percent (5%) of an appropriate cross-linking agent.

### DETAILED DESCRIPTION OF THE PREFERRED EMBODIMENT

The present invention begins with a standard, prior art monomer blend, which may take the form of a polymerizable water soluble monomer, a water soluble monomer having a pendant hydrophobic moiety or a water-insoluble monomer having pendant hydrophilic moieties. The monomer blend comprises a carboxylic acid-containing monomer(s) and preferably an acrylic acid monomer blend comprising acrylic acid and one or more acrylic acid monomer derivatives, such as a dimer or trimer of acrylic acid. One monomer blend that has proven especially useful for inclusion in the disclosed super-absorbent polymer coating is SP-1006 manufactured by Stockhausen of Greensboro, N.C. However, unlike prior art neutralization techniques, which utilize hydroxyl-containing neutralization agents, such as NaOH, KOH or NH₄OH, to produce a neutralized organic salt and water, the monomer blend of the present invention is neutralized using a water-soluble or partially water-soluble tertiary amine. The result of neutralizing the monomer blend with a tertiary amine, unlike prior art neutralized acids, is a liquid, amine-neutralized salt. The preferred tertiary amines for neutralizing the monomer blend are tri-n-propyl amine and triethyl amine.

This amine-neutralized salt comprises one hundred percent solids and is substantially devoid of volatile nonreactives, such as water or other solvents.

Added to the amine-neutralized salt is substantially between one tenth of one weight percent (0.1) and fifteen weight percent (15%) of one or more three-dimensional cross-linking monomer. The preferred three-dimensional cross-linking monomers used in the invention are propoxylated or ethoxylated trimethylol propane triacrylate. Also added to the amine-neutralized salt is substantially between one-half of one weight percent (0.5%) and five weight percent (5%) of an appropriate cross-linking agent. Cross-linking can be either thermally activated or photo-initiated depending on the cross-linking agent selected. In the preferred embodiment, the cross-linking agent is a photo-initiated cross-linking agent. When exposed to an ultraviolet (UV) light source, the mixture will result in a three-dimensionally cross-linked, water-swellable polymer. Using a UV curable photo-initiated cross-linking agent results in rapid cross-linking of the polymer once the monomer blend is applied to a substrate.

Thus, the resultant cross-linkable mixture provides a flexible water-absorbent polymer coating compound, which is compatible with high speed manufacturing processes and products manufactured therewith. For example, the disclosed coatings can be applied to cable components in order to produce water-swellable cables, which are especially beneficial for submarine applications. Since cables are typically manufactured at rates of hundreds of feet per minute, rapid cross-linking of the coating is essential. The disclosed flexible water-absorbent reactive mixture can be further modified by the addition of one or more substantially mono-functional oligomer, which are added to the reactive mixture to modify the physical properties of the resultant coating compound. For example an oligomer can be included to provide enhanced flexibility to the resultant coating. Other properties that may be beneficial, depending on the ultimate application of the resultant coating, include abrasion resistance, hardness or other physical properties.

In one embodiment of the invention, a water-soluble urethane oligomer is added to the reactive mixture. The water-soluble urethane oligomer provides not only flexibility to the resultant coating but also provides superior adherence characteristics as well. For example, a coating including a urethane oligomer adheres to virtually all plastics, including polyolefins, polyesters, thermoplastic polyurethanes (TPU), and extruded vinyl. All of these plastics are typical components used in the manufacture of cables. Also, the water soluble urethane oligomer adheres to metals.

Optional additives can also be included in the reactive mixture, including surfactants to improve coating characteristics. Another family of additives includes viscosity enhancing co-monomers or polymers, which include comonomers such as acrylamide, vinyl pyrrolidone, vinyl sulphonic acid or salt thereof, acryonitrile or the polymers of these same co-monomers. Additional viscosity enhancing additives include cellulosic monomer, modified cellulosic monomer, polyvinyl alcohol and starch hydrolyzate monomer.

One example of the composition of the disclosed super-absorbent polymer coating compound is provided in Table 1 below.

TABLE 1

| | |
|---|---|
| Amine-Neutralized Salt¹ | 80.8% |
| Trimethylol Propane | 1.9% |
| Triacrylate | |
| Urethane Oligomer | 12.3$ |
| Lamberti KIP-100F | 2% |
| (Photoinitiator) | |
| 3M FC-430 | 1% |
| Surfactant | |
| BF Goodrich Carbopol | 2% |
| (Thickener) | |

Notes:
¹Triethylamine-neutralized acrylic acid.

Modifications and substitutions by one of ordinary skill in the art are considered to be within the scope of the present invention which is not to be limited except by the claims which follow.

What is claimed is:

1. A water-absorbent polymer coating comprising a cross-linked polymer prepared by polymerizing a polymerization mixture, which comprises:
(a) substantially between 35 and 99.9 weight percent of one or more amine neutralized monomer;
(b) substantially between 0.1 and 15 weight percent cross-linking monomer;
(c) substantially between 0 and 50 weight percent water soluble, substantially monofunctional oligomer; and
(d) substantially between 0.5 and 5 weight percent of a cross-linking agent.

2. The water-absorbent polymer coating as claimed in claim 1, wherein said amine neutralized monomer comprises a water soluble monomer having a pendant hydrophiobic moiety.

3. The water-absorbent polymer coating as claimed in claim 1, wherein said amine neutralized monomer comprises a water in-soluble monomer having a pendant hydrophilic moiety.

4. The water-absorbent polymer coating as claimed in claim 1, wherein said amine neutralized monomer comprises a carboxylic acid-containing monomer.

5. The water-absorbent polymer coating as claimed in claim 4 wherein said carboxylic acid-containing monomer comprises acrylic acid.

6. The water-absorbent polymer coating as claimed in claim 5, wherein said carboxylic acid-containing monomer further comprises an acrylic acid derivative.

7. The water-absorbent polymer coating as claimed in claim 1, wherein said amine neutralized monomer comprises a monomer neutralized with a tertiary amine.

8. The water-absorbent polymer coating as claimed in claim 7, wherein said tertiary amine comprises tri-n-propyl amine.

9. The water-absorbent polymer coating as claimed in claim 7, said tertiary amine comprises triethyl amine.

10. The water-absorbent polymer coating as claimed in claim 1, wherein said substantially mono-functional oligomer comprises a urethane oligomer.

11. The water-absorbent polymer coating as claimed in claim 1, wherein said cross-linking monomer comprises trimethylol propane triacrylate.

12. The water-absorbent polymer coating as claimed in claim 1 further comprising substantially between 0 and 5 weight percent of a surfactant.

13. A method of preparing a water-absorbent polymer coating compound comprising the steps of:
(a) neutralizing a polymerizable, water-soluble monomer with a tertiary amine to produce an amine neutralized monomer substantially devoid of volatile non-reactives;
(b) adding substantially between 0.1 and 15 weight percent of a cross-linking monomer to substantially between 35 and 99.9 weight percent of said amine-neutralized monomer;
(c) adding substantially between 0 and 50 weight percent water soluble, substantially mono-functional oligomer to said amine neutralized monomer containing said cross-linking monomer; and
(d) adding substantially between 0.5 and 5 weight percent of a cross-linking agent to said monomer.

14. The method claimed in claim 13, wherein said step of neutralizing said polymerizable, water-soluble monomer comprises adding, by titration a tertiary amine to an acrylic acid monomer until said monomer measures a pH of substantially 7.

15. The method claimed in claim 13 further comprising adding at least one surfactant to said coating compound to improve coating characteristics.

16. The method claimed in claim 13 further comprising adding at least one viscosity enhancing comonomer to said coating compound, said viscosity enhancing comonomer selected from the group consisting of acrylamide, vinyl pyrrolidone, vinyl sulphonic acid or a salt thereof, acryonitriles, cellulosic monomers, modified cellulosic monomers, polyvinyl alcohol and starch hydrolyzate monomers.

17. A method of providing a water-absorbent polymer coated article comprising the steps of:
(a) neutralizing a polymerizable, water-soluble monomer with a tertiary amine to produce an amine neutralized monomer substantially devoid of volatile non-reactives;
(b) adding substantially between 0.1 and 15 weight percent of a cross-linking monomer to substantially between 35 and 99.9 weight percent of said amine neutralized monomer;
(c) adding substantially between 0 and 50 weight percent water soluble, substantially mono-functional oligomer to said amine neutralized monomer containing said cross-linking monomer;
(d) adding substantially between 0.5 and 5 weight percent of a cross-linking agent to said monomer to produce a water-swellable coating compound;
(e) coating said article with said water-swellable coating compound; and
(f) cross-linking said water-swellable coating compound.

18. The method claimed in claim 17, wherein said cross-linking agent comprises a photo-initiated cross-linker and said step of cross-linking said water-swellable coating compound comprises exposing said coated article to an ultraviolet (UV) light source.
